(19) United States
(12) Patent Application Publication
(10) Pub. No.: US 2023/0413229 A1
(43) Pub. Date: Dec. 21, 2023

(54) Method and Apparatus for Relay Communication

(71) Applicant: Telefonaktiebolaget LM Ericsson (publ), Stockholm (SE)

(72) Inventors: Min Wang, Luleå (SE); Antonino Orsino, Kirkkonummi (FI)

(21) Appl. No.: 18/032,652

(22) PCT Filed: Oct. 4, 2021
(86) PCT No.: PCT/EP2021/077316

§ 371 Date: Apr. 19, 2023

(30) Foreign Application Priority Data
Oct. 21, 2020 (WO) PCT/EP2020/079606

(51) Int. Cl. H04W 68/00

(52) U.S. Cl. CPC H04W 68/005; H04W 88/04

(57) ABSTRACT

Various embodiments of the present disclosure provide a method for relay communication. The method which may be performed by a first user equipment comprises receiving one or more messages for a second user equipment from a base station. The one or more messages may include a first paging message in physical layer signaling. In accordance with an exemplary embodiment, the method further comprises forwarding the one or more messages to the second user equipment.

### FIELD OF THE INVENTION

The present disclosure generally relates to communication networks, and more specifically, to a method and apparatus for relay communication.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network, direct unicast transmission over a sidelink (SL) between two V2X capable UEs may be needed in some applications such as platooning, cooperative driving, dynamic ride sharing, etc. For a remote UE in the network (NW), e.g., a UE that may be out of cell coverage and may not be able to connect with a network node directly, a UE-to-NW relay UE (also called U2N relay for short) may provide the functionality to support connectivity to the NW for the remote UE. In this case, uplink/downlink (UL/DL) traffics of the remote UE may be forwarded by the U2N relay. In some cases, the remote UE may communicate with another UE via one or more UE-to-UE relay UEs (also called U2U relays for short), and various traffics of the remote UE may be forwarded by the one or more U2U relays. In a UE-to-NW relay scenario, a base station may not be able to reach the remote UE through a short message or a paging message because the remote UE may have no direct connection with the base station. Therefore, it may be desirable to support short/paging messages for a remote UE in a more efficient way.

Various exemplary embodiments of the present disclosure propose a solution for relay communication, which may enable a short message and/or a paging message from a base station to be relayed to a remote UE by various signaling transmissions. According to the proposed solution, short/paging messages may be supported in a relay scenario while saving power consumption and reducing signaling overhead.

It can be appreciated that the “remote UE” described in this document may refer to a UE that may communicate with a relay UE e.g. via PC5/SL interface, and/or communicate with a network node e.g. via Uu interface. As an example, the remote UE may be a 5G proximity-based services (ProSe) enabled UE that may communicate with a data network (DN) via a ProSe 5G UE-to-NW relay UE. As another example, the remote UE may be a 5G ProSe enabled UE that may communicate with another UE via a ProSe 5G UE-to-UE relay UE.

It can be appreciated that the “relay UE” described in this document may refer to the “UE-to-NW relay UE” or the “UE-to-UE relay UE”. As an example, the relay UE may be a 5G ProSe enabled UE that is capable of supporting connectivity to the NW and/or other UE(s) for the remote UE.

It can be appreciated that the “UE-to-NW relay UE” described in this document may also be referred to as “UE-to-Network relay UE”, “UE-to-Network relay” and “UE-to-NW relay”. Thus, the terms “UE-to-NW relay UE”, “UE-to-Network relay UE”, “UE-to-Network relay” and “UE-to-NW relay” may be used interchangeably in this document.

Similarly, it can be appreciated that the “UE-to-UE relay UE” described in this document may also be referred to as “UE-to-UE relay”. Thus, the terms “UE-to-UE relay UE” and “UE-to-UE relay” may be used interchangeably in this document.

It can be appreciated that the term “short message” described in this document may refer to a message (e.g., a paging message) carried in physical layer (L1) signaling. In a relay scenario as described in various embodiments, a base station may send a short message intended for a remote UE via a relay UE.

It can be appreciated that the term “long message” described in this document may refer to a message (e.g., a paging message) carried in signaling on a protocol layer above physical layer (L1). As an example, the long message may be a paging message carried in radio resource control (RRC) signaling. In a relay scenario as described in various embodiments, a base station may send a long message intended for a remote UE via a relay UE.

According to a first aspect of the present disclosure, there is provided a method performed by a first UE such as a relay capable UE. The method comprises: receiving one or more messages for a second UE from a base station. The one or more messages may include a first paging message in physical layer (L1) signaling. In accordance with an exemplary embodiment, the method further comprises: forwarding the one or more messages to the second UE.

In accordance with an exemplary embodiment, the first UE may forward the one or more messages to the second UE in a groupcast or broadcast transmission.

In accordance with an exemplary embodiment, the first UE may forward the one or more messages to the second UE in a dedicated transmission.

In accordance with an exemplary embodiment, the first UE may forward the one or more messages to the second UE in one or more of:
sidelink control information (SCI) signaling;
radio resource control (RRC) signaling;
a control element for medium access control (MAC CE); and
a control data unit (e.g., a control protocol data unit (PDU), etc.).

In accordance with an exemplary embodiment, the SCI signaling may include one or more of:
an indicator of the first paging message;
the first paging message;
a frequency domain resource assignment; and
a time domain resource assignment.

In accordance with an exemplary embodiment, the one or more messages may further include a second paging message in signaling on a protocol layer above the physical layer.

In accordance with an exemplary embodiment, the SCI signaling may include one or more of:
an indicator of the first paging message;
the first paging message;
a frequency domain resource assignment;
a time domain resource assignment;
an indicator of the second paging message; and
paging information of the second UE.

In accordance with an exemplary embodiment, the first UE may forward the one or more messages to the second UE according to a configuration by the base station.

In accordance with an exemplary embodiment, the first UE may forward the one or more messages to the second UE according to a predetermined configuration.

In accordance with an exemplary embodiment, the method according to the first aspect of the present disclosure may further comprise: receiving status information from the second UE. The status information may indicate activity status of the second UE.

In accordance with an exemplary embodiment, the status information may include one or more of:
one or more time occasions during which the second UE is active;
duration of the second UE being in active state;
radio link status;
buffer status;
power headroom;
mobility status; and
one or more measurement results of a link between the first UE and the second UE.

In accordance with an exemplary embodiment, the method according to the first aspect of the present disclosure may further comprise: forwarding the status information of the second UE to the base station.

In accordance with an exemplary embodiment, the method according to the first aspect of the present disclosure may further comprise: scheduling one or more transmissions to the second UE according to the status information of the second UE.

In accordance with an exemplary embodiment, the one or more messages may further include an indicator indicating whether the one or more messages are for the first UE and/or for the second UE.

In accordance with an exemplary embodiment, the first UE may be configured with capability information indicating whether the first UE supports the first paging message and/or the second paging message in relay communication.

In accordance with an exemplary embodiment, the second UE may be configured with capability information indicating whether the second UE supports the first paging message and/or the second paging message in relay communication.

According to a second aspect of the present disclosure, there is provided an apparatus which may be implemented as a first UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first UE. The apparatus may comprise a receiving unit and a forwarding unit. In accordance with some exemplary embodiments, the receiving unit may be operable to carry out at least the receiving step of the method according to the first aspect of the present disclosure. The forwarding unit may be operable to carry out at least the forwarding step of the method according to the first aspect of the present disclosure.

According to a fifth aspect of the present disclosure, there is provided a method performed by a second UE such as a remote UE. The method comprises: receiving one or more messages from a base station via a first UE. The one or more messages may include a first paging message in physical layer signaling.

In accordance with an exemplary embodiment, the second UE may receive the one or more messages in a groupcast or broadcast transmission from the first UE.

In accordance with an exemplary embodiment, the second UE may receive the one or more messages in a dedicated transmission from the first UE.

In accordance with an exemplary embodiment, the second UE may receive the one or more messages from the first UE in SCI signaling, RRC signaling, a MAC CE and/or a control data unit.

In accordance with an exemplary embodiment, the one or more messages may further include a second paging message in signaling on a protocol layer above the physical layer.

In accordance with an exemplary embodiment, the second UE may receive the one or more messages from the first UE according to a configuration by the base station.

In accordance with an exemplary embodiment, the second UE may receive the one or more messages from the first UE according to a predetermined configuration.

In accordance with an exemplary embodiment, the one or more messages received by the second UE according to the fifth aspect of the present disclosure may correspond to the one or more messages forwarded by the first UE according to the first aspect of the present disclosure. Thus, the one or more messages according to the first and fifth aspects of the present disclosure may have the same or similar contents and/or feature elements.

In accordance with an exemplary embodiment, the SCI signaling according to the fifth aspect of the present disclosure may correspond to the SCI signaling according to the first aspect of the present disclosure. Thus, the SCI signaling according to the first and fifth aspects of the present disclosure may have the same or similar contents and/or feature elements.

In accordance with an exemplary embodiment, the method according to the fifth aspect of the present disclosure may further comprise: transmitting status information to the first UE. The status information may indicate activity status of the second UE.

In accordance with an exemplary embodiment, the status information according to the fifth aspect of the present disclosure may correspond to the status information according to the first aspect of the present disclosure. Thus, the status information according to the first and fifth aspects of the present disclosure may have the same or similar contents and/or feature elements.

According to a sixth aspect of the present disclosure, there is provided an apparatus which may be implemented as a second UE. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second UE. The apparatus may comprise a receiving unit and optionally a transmitting unit. In accordance with some exemplary embodiments, the receiving unit may be operable to carry out at least the receiving step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a base station. The method comprises: transmitting one or more messages to a second UE via a first UE. The one or more messages may include a first paging message in physical layer signaling.

In accordance with an exemplary embodiment, the one or more messages may further include a second paging message in signaling on a protocol layer above the physical layer.

In accordance with an exemplary embodiment, the one or more messages transmitted by the base station according to the ninth aspect of the present disclosure may correspond to the one or more messages forwarded to the second UE by the first UE according to the first aspect of the present disclosure. Thus, the one or more messages according to the first and ninth aspects of the present disclosure may have the same or similar contents and/or feature elements.

In accordance with an exemplary embodiment, the method according to the ninth aspect of the present disclosure may further comprise: informing the first UE of a configuration about forwarding the one or more messages from the first UE to the second UE.

In accordance with an exemplary embodiment, the method according to the ninth aspect of the present disclosure may further comprise: receiving status information of the second UE from the first UE. The status information indicates activity status of the second UE.

In accordance with an exemplary embodiment, the method according to the ninth aspect of the present disclosure may further comprise: scheduling one or more transmissions to the second UE according to the status information of the second UE.

In accordance with an exemplary embodiment, the status information according to the ninth aspect of the present disclosure may correspond to the status information according to the first aspect of the present disclosure. Thus, the status information according to the first and ninth aspects of the present disclosure may have the same or similar contents and/or feature elements.

According to a tenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a base station. The apparatus may comprise a transmitting unit and optionally a receiving unit. In accordance with some exemplary embodiments, the transmitting unit may be operable to carry out at least the transmitting step of the method according to the ninth aspect of the present disclosure. The receiving unit may be operable to carry out at least the receiving step of the method according to the ninth aspect of the present disclosure.

According to a thirteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth aspect of the present disclosure.

According to a fourteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth aspect of the present disclosure.

According to a fifteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first or fifth aspect of the present disclosure.

According to a sixteenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first or fifth aspect of the present disclosure.

According to a seventeenth aspect of the present disclosure, there is provided a method implemented in a communication system which may include a host computer, a base station and a UE. The method may comprise, at the host computer, receiving user data transmitted to the base station from the UE which may perform any step of the method according to the first or fifth aspect of the present disclosure.

According to an eighteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first or fifth aspect of the present disclosure.

According to a nineteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth aspect of the present disclosure.

According to a twentieth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an exemplary architecture model using a proximity-based services (ProSe) 5G UE-to-Network relay according to an embodiment of the present disclosure;

FIG. 2A is a diagram illustrating an exemplary protocol stack for layer-3 (L3) UE-to-NW relay according to an embodiment of the present disclosure;

FIG. 2B is a diagram illustrating an exemplary connection procedure with a ProSe 5G UE-to-NW relay according to an embodiment of the present disclosure;

FIG. 3A is a diagram illustrating an exemplary user plane stack for layer-2 (L2) UE-to-Network relay according to an embodiment of the present disclosure;

FIG. 3B is a diagram illustrating an exemplary control plane stack for L2 UE-to-Network relay according to an embodiment of the present disclosure;

FIG. 3C is a diagram illustrating exemplary connection establishment for indirect communication via a UE-to-Network relay according to an embodiment of the present disclosure;

FIGS. 4A-4C are flowcharts illustrating various methods according to some embodiments of the present disclosure;

FIG. 5 is a block diagram illustrating an apparatus according to some embodiments of the present disclosure;

FIGS. 6A-6C are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaining terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

In a wireless communication network, paging may allow the network to reach UEs in RRC_IDLE and in RRC_INACTIVE state through paging messages, and to notify UEs in RRC_IDLE, RRC_INACTIVE and RRC_CONNECTED state of system information change and earthquake and tsunami warning system/commercial mobile alert system (ETWS/CMAS) indications through short messages, e.g., as described in 3GPP technical specification (TS) 38.300 V16.3.0, where the entire content of this technical specification is incorporated into the present disclosure by reference. Both paging messages and short messages may be addressed with a paging-radio network temporary identity (P-RNTI) on a physical downlink control channel (PDCCH), but while the former is sent on a paging control channel (PCCH), and the latter is sent over PDCCH directly (e.g., as described in clause 6.5 of 3GPP TS 38.331 V16.2.0, where the entire content of this technical specification is incorporated into the present disclosure by reference).

While in RRC_IDLE the UE may monitor the paging channels for core network-initiated (CN-initiated) paging; in RRC_INACTIVE the UE may also monitor paging channels for radio access network-initiated (RAN-initiated) paging. A UE may need not monitor paging channels continuously though. Paging discontinuous reception (DRX) may be defined where the UE in RRC_IDLE or RRC_INACTIVE is only required to monitor paging channels during one paging occasion (PO) per DRX cycle (e.g., as described in 3GPP TS 38.304 V16.2.0, where the entire content of this technical specification is incorporated into the present disclosure by reference). As an example, the paging DRX cycles may be configured by the network as below:
For CN-initiated paging, a default cycle may be broadcast in system information;
For CN-initiated paging, a UE specific cycle may be configured via non-access stratum (NAS) signaling;
For RAN-initiated paging, a UE-specific cycle may be configured via radio resource control (RRC) signaling;

The UE may use the shortest of the DRX cycles applicable, e.g., a UE in RRC_IDLE may use the shortest of the first two cycles above, while a UE in RRC_INACTIVE may use the shortest of the three.

The POs of a UE for CN-initiated and RAN-initiated paging may be based on the same UE identifier/identity (ID), resulting in overlapping POs for both. The number of different POs in a DRX cycle may be configurable via system information and a network may distribute UEs to those POs based on their IDs.

When in RRC_CONNECTED, the UE may monitor the paging channels in any PO signaled in system information for system information (SI) change indication and public warning system (PWS) notification. In case of bandwidth adaptation (BA), a UE in RRC_CONNECTED may only monitor paging channels on the active bandwidth part (BWP) with common search space configured.

For operation with shared spectrum channel access, a UE may be configured for an additional number of PDCCH monitoring occasions in its PO to monitor for paging. However, when the UE detects a PDCCH transmission within the UE's PO addressed with P-RNTI, the UE may not be required to monitor the subsequent PDCCH monitoring occasions within this PO.
Paging optimization for UEs in CM_IDLE: at UE context release, the NG-RAN node may provide the mobility management function (AMF) with a list of recommended cells and new generation-radio access network (NG-RAN) nodes as assistance information for subsequent paging. The AMF may also provide paging attempt information consisting of a paging attempt count and the intended number of paging attempts and may include the next paging area scope. If paging attempt information is included in the paging message, each paged NG-RAN node receives the same information during a paging attempt. The paging attempt count may be increased by one at each new paging attempt. The next paging area scope, when present, may indicate whether the AMF plans to modify the paging area currently selected at next paging attempt. If the UE has changed its state to CM_CONNECTED, the paging attempt count may be reset.
Paging optimization for UEs in RRC_INACTIVE: at RAN paging, the serving NG-RAN node may provide RAN paging area information. The serving NG-RAN node may also provide RAN paging attempt information. Each paged NG-RAN node may receive the same RAN paging attempt information during a paging attempt with the following content: paging attempt count, the intended number of paging attempts and the next paging area scope. The paging attempt count may be increased by one at each new paging attempt. The next paging area scope, when present, may indicate whether the serving NG_RAN node plans to modify the RAN paging area currently selected at next paging attempt. If the UE leaves RRC_INACTIVE state, the paging attempt count may be reset.

In accordance with an exemplary embodiment, e.g., as described in 3GPP TS 38.304 V16.2.0, the UE may use DRX in RRC_IDLE and RRC_INACTIVE state in order to reduce power consumption. The UE may monitor one paging occasion (PO) per DRX cycle. A PO is a set of PDCCH monitoring occasions and may consist of multiple time slots (e.g. subframe or orthogonal frequency division multiplexing (OFDM) symbol) where paging downlink control information (DCI) may be sent (e.g., as described in 3GPP TS 38.213 V16.3.0, where the entire content of this technical specification is incorporated into the present disclosure by reference). One paging frame (PF) is one radio frame and may contain one or multiple PO(s) or starting point of a PO.

In multi-beam operations, the UE may assume that the same paging message and the same short message are repeated in all transmitted beams and thus the selection of the beam(s) for the reception of the paging message and short message is up to UE implementation. The paging message is the same for both RAN-initiated paging and CN-initiated paging.

The UE may initiate an RRC connection resume procedure upon receiving RAN-initiated paging. If the UE receives CN-initiated paging in RRC_INACTIVE state, the UE may move to RRC_IDLE and inform NAS.

In accordance with an exemplary embodiment, the PF and PO for paging may be determined by the following formulas:
The system frame number (SFN) for the PF may be determined by:

(SFN+PF_offset) mod T=(T div N)*(UE_ID mod N) (1)
The index (i_s) indicating the index of the PO may be determined by:

i_s=floor (UE_ID/N) mod Ns (2)

The PDCCH monitoring occasions for paging may be determined according to pagingSearchSpace, e.g., as described in 3GPP TS 38.213 V16.3.0 and firstPDCCH-MonitoringOccasionOfPO and nrofPDCCH-MonitoringOccasionPerSSB-InPO if configured e.g. as described in 3GPP TS 38.331 V16.2.0. When SearchSpaceId=0 is configured for pagingSearchSpace, the PDCCH monitoring occasions for paging are the same as for remaining minimum system information (RMSI), e.g. as described in clause 13 of 3GPP TS 38.213 V16.3.0.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)th PO. A PO is a set of ‘S*X’ consecutive PDCCH monitoring occasions, where S is the number of actual transmitted synchronization signal and physical broadcast channel blocks (SSBs) determined according to ssb-PositionsInBurst in system information block 1 (SIB1), and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0, 1, . . . , X−1, and K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. If X>1, when the UE detects a PDCCH transmission addressed to P-RNTI within its PO, the UE may not be required to monitor the subsequent PDCCH monitoring occasions for this PO. In an embodiment, a PO associated with a PF may start in the PF or after the PF. In another embodiment, the PDCCH monitoring occasions for a PO may span multiple radio frames. When SearchSpaceId other than 0 is configured for paging-SearchSpace, the PDCCH monitoring occasions for a PO may span multiple periods of the paging search space.

As an example, the following parameters may be used for the calculation of PF and i_s above:
T: the DRX cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: the number of total paging frames in T.
Ns: the number of paging occasions for a PF.
PF offset: the offset used for PF determination.
UE_ID: 5G system architecture evolution (SAE) temporary mobile subscriber identity (5G-S-TMSI) mod 1024.

In accordance with an exemplary embodiment, parameters Ns, nAndPagingFrameOffset, nrofPDCCH-MonitoringOccasionPerSSB-InPO, and the length of default DRX cycle may be signaled in SIB1. The values of N and PF_offset may be derived from the parameter nAndPagingFrameOffSet e.g. as described in 3GPP TS 38.331 V16.2.0. The parameter first-PDCCH-MonitoringOccasionOfPO may be signaled in SIB1 for paging in initial DL BWP. For paging in a DL BWP other than the initial DL BWP, the parameter first-PDCCH-MonitoringOccasionOfPO may be signaled in the corresponding BWP configuration.

If the UE has no 5G-S-TMSI, for instance when the UE has not yet registered onto the network, the UE may use as default identity UE_ID=0 in the PF and i_s formulas above. The 5G-S-TMSI may be a 48-bit long bit string, e.g. as described in 3GPP TS 23.501 V16.5.0, where the entire content of this technical specification is incorporated into the present disclosure by reference. The 5G-S-TMSI may be interpreted as a binary number where the left most bit represents the most significant bit.

In an exemplary paging procedure e.g. as described in 3GPP TS 38.300 V16.3.0 and TS 38.304 V16.2.0, the paging message may be sent to the UE over the UU interface, i.e. the normal DL. It may also be observed that the PO that a specific UE monitors may depend on its UE ID (and other parameters configured by RRC signaling), meaning that different UEs may or may not monitor the same POs. This may ensure that different UEs are more or less equally distributed over different POs to avoid congestion.

In accordance with an exemplary embodiment, as described in clause 6.5 of 3GPP TS 38.331 V16.2.0, short messages may be transmitted on PDCCH using P-RNTI with or without associated paging message using short message field in DCI format 1_0 (e.g., as described in clause 7.3.1.2.1 of 3GPP TS 38.212 V16.3.0, where the entire content of this technical specification is incorporated into the present disclosure by reference). Table 1 gives some exemplary short messages, where bit 1 is the most significant bit, as described in 3GPP TS 38.331 V16.2.0.

TABLE 1

| Bit | Short Message |
|---|---|
| 1 | systemInfoModification |
| | If set to 1: indication of a BCCH modification other than SIB6, SIB7 |
| | and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum channel |
| | access and if nrofPDCCH-MonitoringOccasionPerSSB-InPO is |
| | present. If set to 1: indication that the UE may stop monitoring |
| | PDCCH occasion(s) for paging in this Paging Occasion as specified |
| | in 3GPP TS 38.304, clause 7.1. |
| 4-8 | Not used in this release of the specification, and may be ignored by |
| | UE if received. |

In accordance with an exemplary embodiment, the information fields in DCI format 1_0 addressed to P-RNTI may be defined, as captured in clause 7.3.1.2.1 of 3GPP TS 38.212 V16.3.0. For example, the following information is transmitted by means of the DCI format 1_0 with CRC scrambled by P-RNTI:
Short Messages Indicator: 2 bits. e.g., according to Table 7.3.1.2.1-1 in 3GPP TS 38.212 V16.3.0.
Short Messages: 8 bits, e.g., according to clause 6.5 of 3GPP TS 38.331 V16.2.0. If only the scheduling information for paging is carried, this bit field may be reserved.
Frequency domain resource assignment: ┌log₂(N_{RB}^{DL,BWP}(N_{RB}^{DL,BWP}+1)/2)┐ bits. If only the short message is carried, this bit field may be reserved.
N_{RB}^{DL,BWP} is the size of CORESET 0.
Time domain resource assignment: 4 bits, e.g., as described in clause 5.1.2.1 of 3GPP TS 38.214 V16.3.0, where the entire content of this technical specification is incorporated into the present disclosure by reference. If only the short message is carried, this bit field may be reserved.
VRB-to-PRB (virtual resource block to physical resource block) mapping: 1 bit, e.g., according to Table 7.3.1.2.2-5 in 3GPP TS 38.212 V16.3.0. If only the short message is carried, this bit field may be reserved.
Modulation and coding scheme: 5 bits, e.g., as described in clause 5.1.3 of 3GPP TS 38.214 V16.3.0, using Table 5.1.3.1-1. If only the short message is carried, this bit field may be reserved.
Transport block (TB) scaling: 2 bits, e.g., as described in clause 5.1.3.2 of 3GPP TS 38.214 V16.3.0. If only the short message is carried, this bit field may be reserved.
Reserved bits: 8 bits for operation in a cell with shared spectrum channel access; otherwise 6 bits.

According to the above information, depending on whether the field “Frequency domain resource assignment” is present or reserved in the received DCI format 1_0, the UE may determine whether a paging message is transmitted on physical downlink shared channel (PDSCH).

Sidelink transmissions over NR are specified by 3GPP for Release 16. These are some enhancements of the ProSe specified for LTE. As an example, four new enhancements are particularly introduced to NR sidelink transmissions as follows:
Not only broadcast but also unicast and groupcast are supported in sidelink transmissions. For unicast and groupcast, the physical sidelink feedback channel (PSFCH) is newly introduced for a receiving UE to reply the decoding status to a transmitting UE.
To improve the latency performance, grant-free transmissions that are adopted in NR uplink transmissions are also provided in NR sidelink transmissions.
To alleviate resource collisions among different sidelink transmissions launched by different UEs, it enhances channel sensing and resource selection procedures, which also lead to a new design of physical sidelink common control channel (PSCCH).
To achieve a high connection density, congestion control and thus the quality of service (QoS) management is supported in NR sidelink transmissions.

In order to enable the above enhancements, some new physical channels and reference signals may be introduced in NR (available in LTE before) as follows:
Physical Sidelink Shared Channel (PSSCH, SL version of PDSCH): The PSSCH may be transmitted by a sidelink transmitting UE, which may convey sidelink transmission data, system information blocks (SIBs) for radio resource control (RRC) configuration, and a part of the sidelink control information (SCI).
Physical Sidelink Feedback Channel (PSFCH, SL version of physical uplink control channel (PUCCH)): The PSFCH may be transmitted by a sidelink receiving UE for unicast and groupcast, which may convey 1-bit information over 1 RB for the hybrid automatic repeat request (HARQ) acknowledgement (ACK) and the negative ACK (NACK). In addition, channel state information (CSI) may be carried in the medium access control (MAC) control element (CE) over the PSSCH instead of the PSFCH.
Physical Sidelink Common Control Channel (PSCCH, SL version of PDCCH): When the traffic to be sent to a receiving UE arrives at a transmitting UE, a transmitting UE may first send the PSCCH, which may convey a part of sidelink control information (SCI, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (SPSS/SSSS): Similar to downlink transmissions in NR, in sidelink transmissions, primary and secondary synchronization signals (called SPSS and SSSS, respectively) may be supported. Through detecting the S-PSS and S-SSS, a UE may be able to identify the sidelink synchronization identity (SSID) from the UE sending the SPSS/SSSS. Through detecting the S-PSS/S-SSS, a UE may be therefore able to know the characteristics of the UE transmitting the SPSS/SSSS. A series of processes of acquiring timing and frequency synchronization together with SSIDs of UEs may be called initial cell search. It can be appreciated that the UE sending the SPSS/SSSS may not be necessarily involved in sidelink transmissions, and a node (e.g., a UE/eNB/gNB) sending the SPSS/SSSS may be called a synchronization source.
Physical Sidelink Broadcast Channel (PSBCH): The PSBCH may be transmitted along with the SPSS/SSSS as a synchronization signal/PSBCH block (SSB). The SSB may have the same numerology as PSCCH/PSSCH on that carrier, and an SSB may be transmitted within the bandwidth of the configured bandwidth part (BWP). The PSBCH may convey information related to synchronization, such as the direct frame number (DFN), an indication of the slot and symbol level time resources for sidelink transmissions, an in-coverage indicator, etc. The SSB may be transmitted periodically at every 160 ms.
DMRS, phase tracking-reference signal (PT-RS), channel state information reference signal (CSI-RS): These physical reference signals supported by NR downlink/uplink transmissions may also be adopted by sidelink transmissions. Similarly, the PT-RS may be only applicable for frequency range 2 (FR2) transmission.

Another new feature is the two-stage SCI, which is a version of the DCI for SL. Unlike the DCI, only part (first stage) of the SCI may be sent on the PSCCH. This part may be used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID may be sent on the PSSCH to be decoded by the receiving UE.

Similar as for ProSe in LTE, NR sidelink transmissions may have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB may be configured to adopt Mode 1 or Mode 2. For the out-of-coverage UE, only Mode 2 may be adopted.

As in LTE, scheduling over the sidelink in NR may be done in different ways for Mode 1 and Mode 2. In accordance with an exemplary embodiment, Mode 1 may support the following two kinds of grants:
Dynamic grant: When the traffic to be sent over sidelink arrives at a transmitting UE, this UE may launch the four-message exchange procedure to request sidelink resources from a gNB (e.g., a scheduling request (SR) on UL, a grant, a buffer status report (BSR) on UL, a grant for data on SL sent to UE). During the resource request procedure, the gNB may allocate a sidelink radio network temporary identifier (SL-RNTI) to the transmitting UE. If this sidelink resource request is granted by the gNB, then the gNB may indicate the resource allocation for the PSCCH and the PSSCH in the DCI conveyed by PDCCH with cyclic redundancy check (CRC) scrambled with the SL-RNTI. When the transmitting UE receives such DCI, the transmitting UE can obtain the grant only if the scrambled CRC of DCI can be successfully solved by the assigned SL-RNTI. The transmitting UE then may indicate the time-frequency resources and the transmission scheme of the allocated PSSCH in the PSCCH, and launch the PSCCH and the PSSCH on the allocated resources for sidelink transmissions. When a grant is obtained from the gNB, the transmitting UE can only transmit a single transport block (TB). As a result, this kind of grant may be suitable for traffic with a loose latency requirement.
Configured grant: For the traffic with a strict latency requirement, performing the four-message exchange procedure to request sidelink resources may induce unacceptable latency. In this case, prior to the traffic arrival, a transmitting UE may perform the four-message exchange procedure and request a set of resources. If a grant can be obtained from a gNB, then the requested resources may be reserved in a periodic manner. Upon traffic arriving at the transmitting UE, this UE may launch the PSCCH and the PS SCH on the upcoming resource occasion. In fact, this kind of grant is also known as grant-free transmissions.

In both dynamic grant and configured grant, a sidelink receiving UE may not receive the DCI (since it is addressed to the transmitting UE), and therefore the receiving UE may perform blind decoding to identify the presence of PSCCH and find the resources for the PSSCH through the SCI.

The SCI may have a first and second part. The first part (sent on PSCCH) may contain reserved time-frequency resources for transmissions, demodulation reference signal (DMRS) pattern and antenna port, etc., and the second part (sent on PSSCH) may contain a 8-bits source identity (ID) and a 16-bits destination ID. SCI may also include a 1-bit new data indicator (NDI), 2-bit redundancy version (RV), and 4-bit HARQ process ID.

In an embodiment, when the transmitting UE launches the PSCCH, CRC may also be inserted in the SCI without any scrambling.

In the Mode 2 resource allocation, when traffic arrives at a transmitting UE, this transmitting UE may autonomously select resources for the PSCCH and the PSSCH. To further minimize the latency of the feedback HARQ ACK/NACK transmissions and subsequently retransmissions, the transmitting UE may also reserve resources for PSCCH/PSSCH for retransmissions. To further enhance the probability of successful TB decoding at one shot and thus suppress the probability to perform retransmissions, the transmitting UE may repeat the TB transmission along with the initial TB transmission. This mechanism is also known as blind retransmission. As a result, when traffic arrives at the transmitting UE, then this transmitting UE may select resources for the following transmissions:
1) The PSSCH associated with the PSCCH for initial transmission and blind retransmissions.
2) The PSSCH associated with the PSCCH for retransmissions.

Since each transmitting UE in sidelink transmissions may autonomously select resources for above transmissions, how to prevent different transmitting UEs from selecting the same resources turns out to be a critical issue in Mode 2. A particular resource selection procedure may be therefore imposed to Mode 2 based on channel sensing. In an embodiment, a channel sensing algorithm may involve measuring reference signal received power (RSRP) on different sub-channels and require knowledge of the different UEs power levels of DMRS on the PSSCH or the DMRS on the PSCCH depending on the configuration. This kind of information may be known only after receiving SCI launched by (all) other UEs.

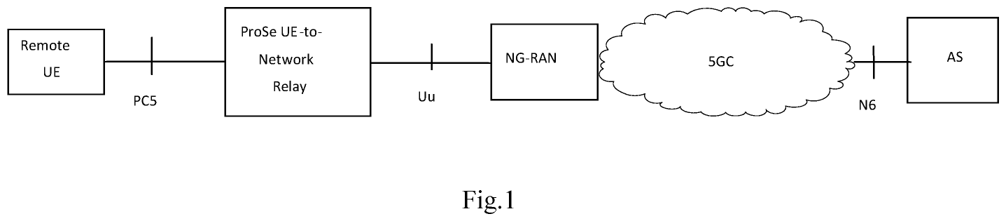

FIG. 1 is a diagram illustrating an exemplary architecture model using a ProSe 5G UE-to-Network relay according to an embodiment of the present disclosure. A network entity such as the ProSe 5G UE-to-Network relay as shown in FIG. 1 may provide the functionality to support connectivity to the network for a remote UE. This connectivity can be used for both public safety services and commercial services (e.g. interactive services, etc.). A UE may be considered to be a remote UE for a certain ProSe UE-to-Network relay if it has successfully established a PC5 link to this ProSe 5G UE-to-Network relay. The remote UE may be located within new generation-radio access network (NG-RAN) coverage or outside of NG-RAN coverage.

The Pro Se 5G UE-to-Network relay may relay unicast traffics (UL and/or DL) between the remote UE and the network. The NG-RAN may connect to a 5G core (5GC) network and then to an application server (AS). The ProSe UE-to-Network relay may provide a generic function that can relay any Internet protocol (IP) traffic. One-to-one direct communication may be used between remote UEs and ProSe 5G UE-to-Network relays for unicast traffics, e.g., as described in 3GPP technical report (TR) 23.752 V0.3.0, where the entire content of this technical report is incorporated into the present disclosure by reference.

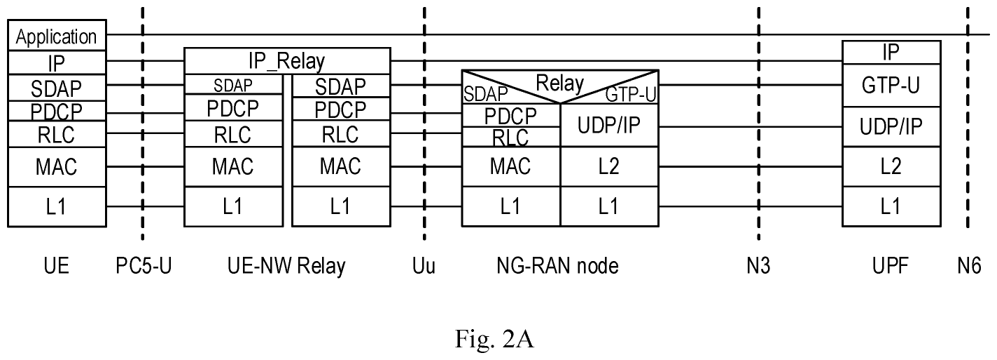

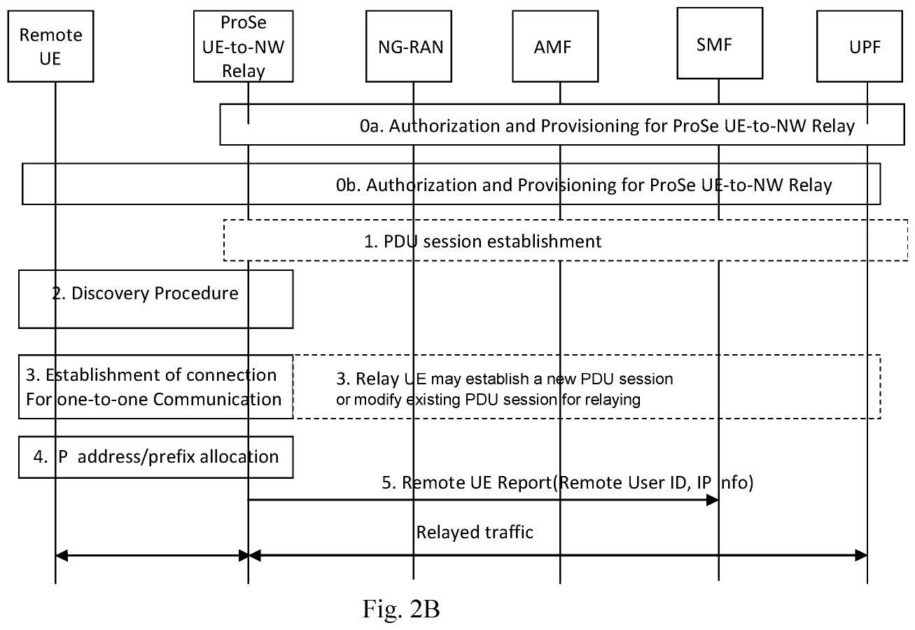

FIG. 2A is a diagram illustrating an exemplary protocol stack for L3 UE-to-NW relay according to an embodiment of the present disclosure. For simplicity, FIG. 2A only depicts exemplary devices/elements, e.g., a remote UE, a L3 UE-to-NW relay, a NG-RAN node and a user plane function (UPF). The L3 UE-to-NW relay may relay unicast traffics (UL/DL) between the remote UE and the NG-RAN node, for example, by providing a generic function that can relay any IP, Ethernet or Unstructured traffic. As an example, the remote UE may have protocol layers including a physical layer (L1), a medium access control (MAC) layer, a radio link control (RLC) layer, a packet data convergence protocol (PDCP) layer, a service data adaptation protocol (SDAP) layer, an IP layer and an application layer. FIG. 2A also shows other network devices/elements with corresponding protocol layers. According to the protocol stack for the L3 UE-to-NW relay as shown in FIG. 2A, hop-by-hop security may be supported in the PC5 link and Uu link. If there are requirements beyond hop-by-hop security for protection of the remote UE's traffic, security over IP layer may be applied. In addition, integrity and privacy protection for the communication between the remote UE and the network may also be applied as needed.

In accordance with an exemplary embodiment, a ProSe 5G UE-to-NW relay capable UE may register to the network (if not already registered) and establish a protocol data unit (PDU) session enabling the necessary relay traffic, or it may need to connect to additional PDU session(s) or modify the existing PDU session in order to provide relay traffic towards remote UE(s). PDU session(s) supporting UE-to-NW relay may only be used for remote ProSe UE(s) relay traffic.

FIG. 2B is a diagram illustrating an exemplary connection procedure with a ProSe 5G UE-to-NW relay according to an embodiment of the present disclosure. For simplicity, FIG. 2B only depicts exemplary devices or functions, e.g., a remote UE, a ProSe 5G UE-to-NW relay, a NG-RAN, a mobility management function (AMF), a session management function (SMF) and a UPF. As shown in FIG. 2B, the exemplary connection procedure with the ProSe 5G UE-to-NW relay may include the following steps:
Step 0: During the registration procedure, authorization and provisioning is performed for the ProSe UE-to-NW relay (in step 0a) and the remote UE (in step 0b), e.g., as described in 3GPP TR 23.752 V0.3.0.
Step 1: The ProSe 5G UE-to-NW relay may establish a PDU session for relaying with default PDU session parameters received in step 0 or pre-configured in the UE-to-NW relay, e.g., single network slice selection assistance information (S-NSSAI), data network name (DNN), service and session continuity (SSC) mode. In case of IPv6, the ProSe UE-to-NW relay obtains the IPv6 prefix via prefix delegation function from the network, e.g., as described in 3GPP TS 23.501 V16.5.0, where the entire content of this technical specification is incorporated into the present disclosure by reference.
Step 2: Based on the authorization and provisioning in step 0, the remote UE performs discovery of a ProSe 5G UE-to-NW relay, e.g., as described in 3GPP TR 23.752 V0.3.0. As part of the discovery procedure, the remote UE learns about the connectivity service the ProSe UE-to-NW relay provides.
Step 3: The remote UE selects a ProSe 5G UE-to-NW relay and establishes a connection for one-to-one ProSe direct communication, e.g., as described in 3GPP TS 23.287 V16.3.0, where the entire content of this technical specification is incorporated into the present disclosure by reference. If there is no PDU session satisfying the requirements of the PC5 connection with the remote UE, e.g. S-NSSAI, DNN, QoS, the ProSe 5G UE-to-NW relay initiates a new PDU session establishment or modification procedure for relaying.
Step 4: IPv6 prefix or IPv4 address is allocated for the remote UE as it is described in clauses 5.4.4.2 and 5.4.4.3 of 3GPP TS 23.303 V16.0.0 (where the entire content of this technical specification is incorporated into the present disclosure by reference). From this point the uplink and downlink relaying can start.
Step 5: The ProSe 5G UE-to-NW relay sends a remote UE report (e.g., including a remote user identity (ID), IP information, etc.) message to the SMF for the PDU session associated with the relay. The remote user ID is an identity of the remote UE user (provided via user information) that is successfully connected in step 3. The SMF stores the remote user ID(s) and the related IP information in the ProSe 5G UE-to-NW relay's context for the PDU connection associated with the relay.

In accordance with an exemplary embodiment, for IP information the following principles may be applied:
for IPv4, the UE-to-NW relay may report transmission control protocol/user datagram protocol (TCP/UDP) port ranges assigned to individual remote UE(s) (along with the remote user ID);
for IPv6, the UE-to-NW relay may report IPv6 prefix(es) assigned to individual remote UE(s) (along with the remote user ID).

In accordance with an exemplary embodiment, the remote UE report message may be sent when the remote UE disconnects from the ProSe 5G UE-to-NW relay (e.g. upon explicit layer-2 link release or based on the absence of keep alive messages over PC5) to inform the SMF that the remote UE(s) have left.

In the case of registration update procedure involving SMF change, the remote user IDs and related IP information corresponding to the connected remote UEs may be transferred to the new SMF as part of session management (SM) context transfer for the ProSe 5G UE-to-NW relay. In order for the SMF to have the remote UE(s) information, the home public lands mobile network (HPLMN) and the visited public lands mobile network (VPLMN) where the ProSe 5G UE-to-NW relay is authorized to operate, may need to support the transfer of the remote UE related parameters in case the SMF is in the HPLMN. When remote UE(s) disconnect from the ProSe UE-to-NW relay, it is up to implementation how relaying PDU sessions are cleared/disconnected by the ProSe 5G UE-to-NW relay.

In accordance with an exemplary embodiment, after being connected to the ProSe 5G UE-to-NW relay, the remote UE may keep performing the measurement of the signal strength of the discovery message sent by the ProSe 5G UE-to-NW relay for relay reselection. The exemplary procedure as shown in FIG. 2B may also work when the ProSe 5G UE-to-NW relay UE connects in the evolved packet system (EPS) using LTE. In this case, for the remote UE report, the procedures as described in 3GPP TS 23.303 V16.0.0 may be used

In accordance with an exemplary embodiment, a L2 UE-to-Network relay UE may provide forwarding functionality that can relay any type of traffic over the PC5 link. For example, the L2 UE-to-Network relay UE may provide the functionality to support connectivity to the 5G system (5GS) for remote UEs. A UE may be considered to be a remote UE if it has successfully established a PC5 link to the L2 UE-to-Network relay UE. The remote UE may be located within NG-RAN coverage or outside of NG-RAN coverage.

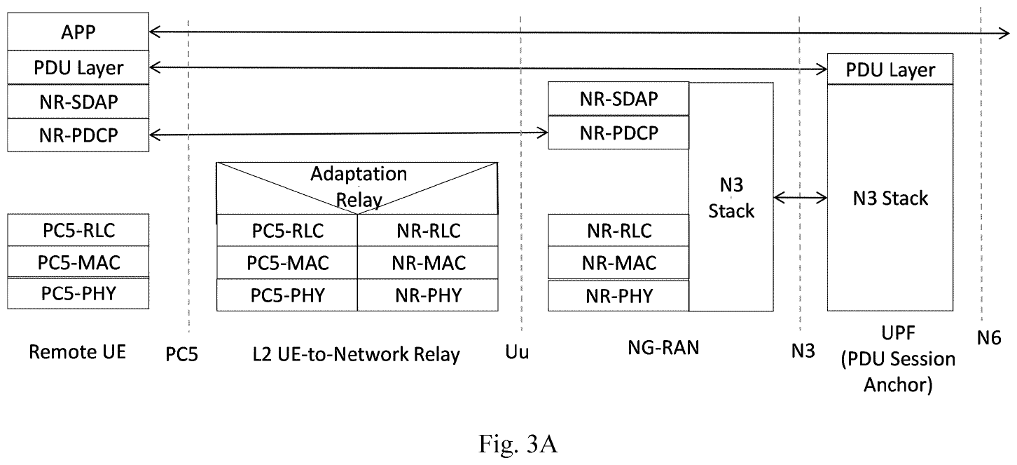

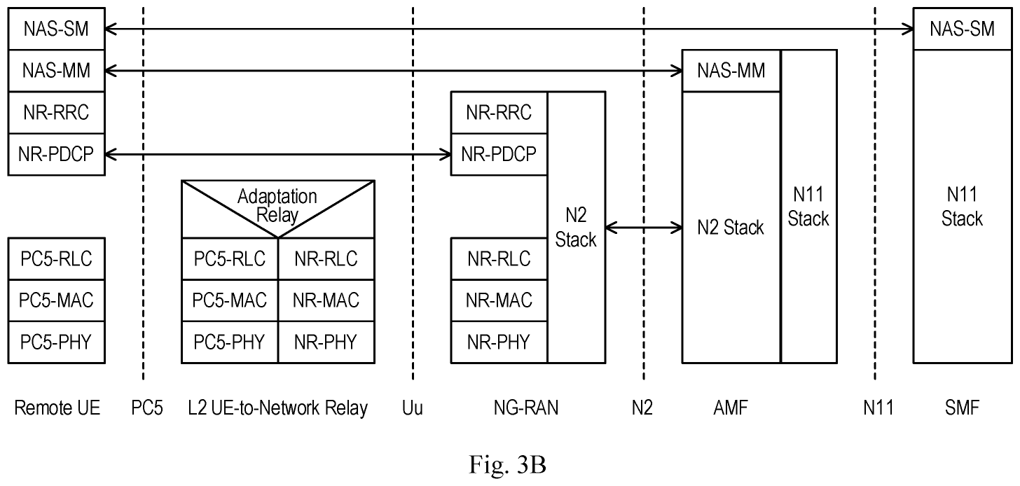

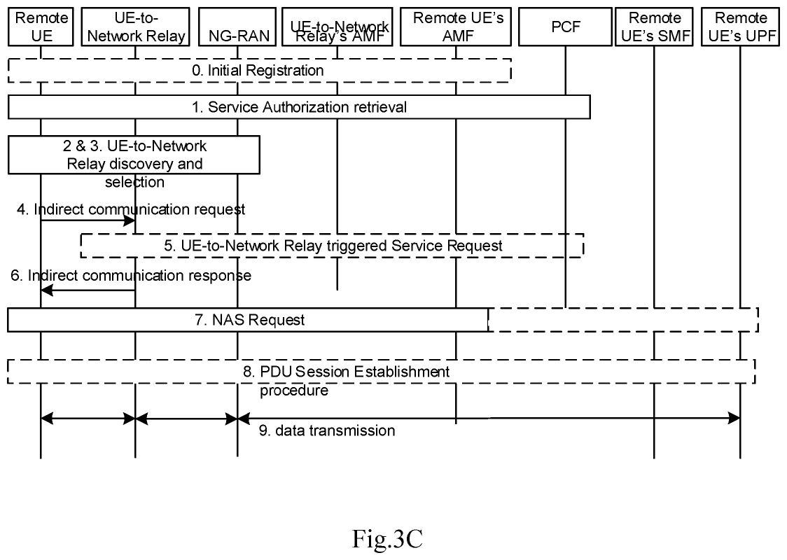

FIG. 3A is a diagram illustrating an exemplary user plane stack for L2 UE-to-Network relay according to an embodiment of the present disclosure. The protocol stack for the user plane transport may be related to a PDU session. The PDU layer corresponds to the PDU carried between the remote UE and the data network (DN) over the PDU session. The two endpoints of the PDCP link are the remote UE and a gNB in the network. The relay function may be performed below the PDCP layer. This means that data security may be ensured between the remote UE and the gNB without exposing raw data at the UE-to-Network relay.

The adaptation relay layer within the UE-to-Network relay can differentiate between signaling radio bearers (SRBs) and data radio bearers (DRBs) for a particular remote UE. The adaption relay layer may also be responsible for mapping PC5 traffic to one or more DRBs of the Uu interface.

FIG. 3B is a diagram illustrating an exemplary control plane stack for L2 UE-to-Network relay according to an embodiment of the present disclosure. The role of the UE-to-Network relay may be to relay the PDUs from the signaling radio bearer without any modifications. The protocol stack as shown in FIG. 3B may be applicable to the non-access stratum (NAS) connection for the remote UE to the non-access stratum-mobility management (NAS-MM) and non-access stratum-session management (NAS-SM) components. The NAS messages may be transparently transferred between the remote UE and 5G access network (5G-AN) over the L2 UE-to-Network relay using:
PDCP end-to-end connection where the role of the UE-to-Network relay is to relay the PDUs over the signalling radio bear without any modifications.
N2 connection between the 5G-AN and AMF over N2.
N3 connection AMF and SMF over N11.

FIG. 3C is a diagram illustrating exemplary connection establishment for indirect communication via a UE-to-Network relay according to an embodiment of the present disclosure. For simplicity, FIG. 3C only depicts exemplary devices or functions, e.g., a remote UE, a UE-to-Network relay, a NG-RAN, a UE-to-Network relay's AMF, a remote UE's AMF, a policy charging function (PCF), a remote UE's SMF and a remote UE's UPF. As shown in FIG. 3C, the exemplary connection establishment procedure for indirect communication via the UE-to-Network relay may include the following steps:
Step 0: If in coverage, the remote UE and the UE-to-Network relay may independently perform the initial registration to the network according to registration procedures, e.g., as described in 3GPP TS 23.502 V16.5.0 (where the entire content of this technical specification is incorporated into the present disclosure by reference). The allocated 5G globally unique temporary UE identity (GUTI) of the remote UE is maintained when later NAS signaling between the remote UE and the network is exchanged via the UE-to-Network relay. The procedure shown in FIG. 3C assumes a single hop relay.
Step 1: If in coverage, the remote UE and the UE-to-Network relay independently get the service authorization for indirect communication from the network.
Steps 2-3: The remote UE and the UE-to-Network relay perform UE-to-Network relay UE discovery and selection.
Step 4: The remote UE initiates a one-to-one communication connection with the selected UE-to-Network relay over PC5, by sending an indirect communication request message to the UE-to-Network relay.
Step 5: If the UE-to-Network relay is in CM_IDLE state, triggered by the communication request received from the remote UE, the UE-to-Network Relay sends a service request message over PC5 to its serving AMF. The UE-to-Network relay's AMF may perform authentication of the UE-to-Network relay based on NAS message validation and if needed the AMF may check the subscription data. If the UE-to-Network relay is already in CM_CONNECTED state and is authorized to perform relay service, then step 5 may be omitted.
Step 6: The UE-to-Network relay sends the indirect communication response message to the remote UE.
Step 7: The remote UE sends a NAS message to the serving AMF. The NAS message may be encapsulated in a radio resource control (RRC) message that is sent over PC5 to the UE-to-Network relay, and the UE-to-Network relay forwards the message to the NG-RAN. The NG-RAN derives the remote UE's serving AMF and forwards the NAS message to this AMF. It is assumed here that the remote UE's PLMN is accessible by the UE-to-Network relay's PLMN and that the UE-to-Network relay's AMF supports all S-NSSAIs that the remote UE may want to connect to. If the remote UE has not performed the initial registration to the network in step 0, the NAS message is initial registration message. Otherwise, the NAS message is a service request message. If the remote UE performs initial registration via the UE-to-Network relay, the remote UE's serving AMF may perform authentication of the remote UE based on NAS message validation and if needed the remote UE's AMF may check the subscription data. For service request case, user plane connection for PDU sessions may also be activated. As an example, the other steps may follow the clause 4.2.3.2 in 3GPP TS 23.502 V16.5.0.
Step 8: The remote UE may trigger the PDU session establishment procedure, e.g., as described in clause 4.3.2.2 of 3GPP TS 23.502 V16.5.0.
Step 9: The data is transmitted between the remote UE and the UPF via the UE-to-Network relay and the NG-RAN. The UE-to-Network relay may forward all the data messages between the remote UE and the NG-RAN using RAN specified L2 relay method.

In a L2 UE-to-Network SL relay scenario, a remote UE may be in different RRC states (e.g., RRC_IDLE, RRC_CONNECTED, or RRC_INACTIVE). If the network wants to reach the remote UE in RRC_IDLE/RRC_INACTIVE state through paging messages, a paging mechanism may need to be supported for the remote UE.

According an exemplary paging mechanism, a relay UE may monitor its linked remote UE's PO in addition to its own PO. The evolved remote UE may not need to attempt paging reception over downlink while linked to the relay UE. The relay UE may need to monitor multiple paging occasions. The relay UE may need to know the paging occasion of the remote UE and to decode a paging message and determine which remote UE the paging is for. Also, the relay UE may need to relay the remote UE's paging over a short-range link. In this way, the relay UE can relay a paging message to the remote UE.

Since the remote UE may have no direct connection to a gNB when the remote UE is connecting to a relay UE e.g. via the SL, a short message sent on PDCCH by the gNB may not be able to reach the remote UE. Therefore, there is a need to study how to improve the existing paging mechanism to make it feasible so that a gNB can page a remote UE via a short message.

Various exemplary embodiments of the present disclosure propose a solution to enable a short message intended for a remote UE to be forwarded by a relay UE to the remote UE flexibly. In addition, various embodiments may also support to relay paging messages from the network to the intended remote UE in different ways. According to various embodiments, power consumption on the SL for short paging message monitoring may be reduced significantly, and the paging signaling overhead on both Uu and SL connections in a relay scenario may also be reduced.

It can be appreciated that although some exemplary embodiments are described in the context of NR, e.g., a remote UE and a relay UE may be deployed in the same NR cell or different NR cells, various embodiments described in the present disclosure may be in general applicable to any kind of communications involving D2D communications. For example, various embodiments described in the present disclosure may also be applicable to other relay scenarios including UE-to-NW relay or UE-to-UE relay where the link between a remote UE and a relay UE may be based on LTE sidelink or NR sidelink, and the Uu connection between a relay UE and a base station may be LTE Uu connection or NR Uu connection. In addition, various embodiments described in the present disclosure may also be applicable to a relay scenario containing multiple relay hops, and/or a relay scenario where a relay UE may be configured with multiple connections (i.e., the number of connections may be equal to or larger than two) to the radio access network (RAN) (e.g., by dual connectivity, carrier aggregation, etc.).

Various embodiments described in the present disclosure may be applicable to L2 relay scenarios. It can be appreciated that the connection between a remote UE and a relay UE may not be limited to sidelink. Any short-range communication technology such as wireless fidelity (WiFi) may also be equally applicable.

In accordance with an exemplary embodiment, during a remote UE's PO over a Uu link, if a relay UE receives a short message which is intended for the remote UE from a gNB, the relay UE may further relay the short message to the remote UE over the SL. In an embodiment, the gNB may also transmit a long message (e.g., a paging message in RRC signaling or other suitable signaling on a protocol layer over the physical layer) together with the short message. In this case, the relay UE may relay both the short message and the long message to the intended remote UE over the SL.

In accordance with an exemplary embodiment, after decoding the short message, the relay UE may apply at least one of the below options to relay the short message to the remote UE.
Option 1 a: carrying the content of the short message using SCI signaling on the SL;
Option 1b: using RRC signaling (e.g., PC5-RRC signaling) to carry the content of the short message on the SL;
Option 1c: using a MAC CE to carry the content of the short message on the SL; and
Option 1d: using a control PDU of a protocol layer such as SDAP, PDCP, RLC or adaptation layer to carry the content of the short message.

In accordance with an exemplary embodiment for Option 1a, the SCI signaling may be transmitted on PSCCH or PSSCH. According to an embodiment, a new SCI format may be defined accordingly. As an example, at least one of the below information may be transmitted via the SCI signaling:
Short Message(s) Indicator, e.g., 2 bits according to Table 7.3.1.2.1-1 of 3GPP TS 38.212 V16.3.0;
Short Message(s): e.g., 8 bits, according to clause 6.5 of 3GPP TS 38.331 V16.2.0. If only the resource assignment information for paging is carried, this bit field may be reserved;
Frequency domain resource assignment; and
Time domain resource assignment.

In accordance with an exemplary embodiment, the gNB may configure the relay UE on which option may be applied to relay a short paging message to the remote UE on the SL. In accordance with another exemplary embodiment, the relay UE may determine to apply which option to relay a short paging message to the remote UE on the SL according to a predetermined configuration.

In accordance with an exemplary embodiment, a relay UE may receive both a short message and a long message (e.g., a paging message in RRC signaling or other suitable signaling on a protocol layer over the physical layer) at the same time for an intended remote UE. In this case, the relay UE may relay both the short message and the long message together to the remote UE over the SL, e.g., via at least one of the below options:
Option 2a: carrying the content of both messages using SCI signaling on the SL;
Option 2b: using RRC signaling (e.g., PC5-RRC signaling) to carry the content of both messages on the SL;
Option 2c: using a MAC CE to carry the content of both messages on the SL; and
Option 2d: using a control PDU of a protocol layer such as SDAP, PDCP, RLC or adaptation layer to carry the content of both messages.

In accordance with an exemplary embodiment for Option 2a, the SCI signaling may be transmitted on PSCCH or PSSCH. According to an embodiment, a new SCI format may be defined accordingly. As an example, at least one of the below information may be transmitted via the SCI signaling:
Short Message(s) Indicator: e.g., 2 bits according to Table 7.3.1.2.1-1 of 3GPP TS 38.212 V16.3.0;
Short Message(s): e.g., 8 bits, according to clause 6.5 of 3GPP TS 38.331 V16.2.0. If only the resource assignment information for paging is carried, this bit field may be reserved;
Frequency domain resource assignment;
Time domain resource assignment;
Long message(s) indicator; and
Other paging information (e.g., UE ID(s), etc.).

In accordance with an exemplary embodiment, the relay UE may just use an existing SCI format to indicate the resource assignment for the relayed message(s).

In accordance with an exemplary embodiment, there may be multiple remote UEs connecting a same relay UE. In this case, the relay UE may relay a short message and/or a long message to the remote UEs in a groupcast or broadcast fashion. Alternatively or additionally, the relay UE may relay a short message and/or a long message to each remote UE in a dedicated transmission fashion.

In accordance with an exemplary embodiment, when the remote UE receives a short message and/or a long message relayed by the relay UE, the remote UE may adjust its activity status (e.g., from less active to more active) to be prepared for the subsequent data transmission from the gNB. In an embodiment, the remote UE may also inform the relay UE of its status information (e.g., new activity information, etc.) which may contain at least one of the below information:
Time occasions during which the remote UE may be active for subsequent data reception;
For how long time period such active state may continue, after that period, the remote UE may become less active;
Radio link status (e.g., radio link strength in terms of RSRP, reference signal received quality (RSRQ), signal to interference plus noise ratio (SINR), signal to interference ratio (SIR), received signal strength indicator (RSSI), constant bit rate (CBR), etc.);
Buffer status (e.g., buffer status report (BSR), etc.);
Power headroom;
Mobility status; and
Any other measurement results of the SL link.

Upon reception of any of the above information, the relay UE may further forward the received information to the gNB. In an embodiment, the relay UE and/or the gNB may schedule subsequent transmissions to the remote UE according to the received information.

In accordance with an exemplary embodiment, a capability bit may be defined or configured for a UE, indicating whether the UE can support short paging message in a relay scenario.

In accordance with an exemplary embodiment, there may be ongoing sidelink relay transmissions. The gNB may include an indication in the short message for informing the relay UE if this short message is for the remote UE, for the relay UE or for both. Further, the gNB may also indicate in the short message to the relay UE how the short message may be delivered (e.g., according to one of the Options 1a-1d and Options 2a-2d as described above). This is may be via an explicit mapping in the short message, or it may be an explicit indication if e.g., the short message is used to deliver the paging message to the relay UE and remote UE.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

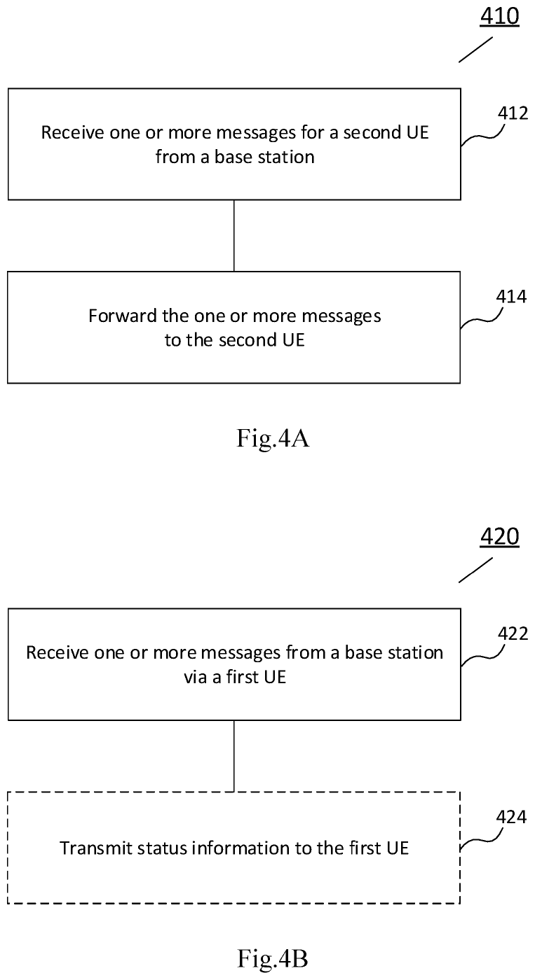

FIG. 4A is a flowchart illustrating a method 410 according to some embodiments of the present disclosure. The method 410 illustrated in FIG. 4A may be performed by a first UE (e.g., a relay capable UE, etc.) or an apparatus communicatively coupled to the first UE. In accordance with an exemplary embodiment, the first UE may be configured to support D2D communication (e.g., V2X or SL communication, etc.) with other devices. In an exemplary embodiment, the first UE may be configured to communicate with a network node (e.g., a gNB, etc.) directly or via a relay (e.g., the UE-to-UE relay, the UE-to-NW relay, etc.).

According to the exemplary method 410 illustrated in FIG. 4A, the first UE may receive one or more messages for a second UE from a base station, as shown in block 412. The one or more messages may include a first paging message (e.g., a short message, etc.) in physical layer (L1) signaling. In accordance with an exemplary embodiment, the first UE may forward the one or more messages to the second UE, as shown in block 414.

In accordance with an exemplary embodiment, the first UE may forward the one or more messages to the second UE in a groupcast or broadcast transmission. In accordance with another exemplary embodiment, the first UE may forward the one or more messages to the second UE in a dedicated transmission.

In accordance with an exemplary embodiment, the first UE may forward the one or more messages to the second UE in one or more of:
SCI signaling;
RRC signaling;
a MAC CE; and
a control data unit (e.g., a control PDU, etc.).

In accordance with an exemplary embodiment, the SCI signaling may include one or more of:
an indicator of the first paging message;
the first paging message;
a frequency domain resource assignment; and
a time domain resource assignment.

In accordance with an exemplary embodiment, the one or more messages may further include a second paging message in signaling on a protocol layer above the physical layer. As an example, the second paging message may be associated with the first paging message.

In accordance with an exemplary embodiment, the SCI signaling may include one or more of:
an indicator of the first paging message;
the first paging message;
a frequency domain resource assignment;
a time domain resource assignment;
an indicator of the second paging message; and
paging information of the second UE.

In accordance with an exemplary embodiment, the first UE may forward the one or more messages to the second UE according to a configuration by the base station. In accordance with another exemplary embodiment, the first UE may forward the one or more messages to the second UE according to a predetermined configuration.

In accordance with an exemplary embodiment, the first UE may receive status information from the second UE. The status information may indicate activity status of the second UE. According to an exemplary embodiment, the status information may include one or more of:
one or more time occasions during which the second UE is active;
duration of the second UE being in active state;
radio link status (e.g., channel quality, signal strength, etc.);
buffer status (e.g., a BSR, etc.);
power headroom;
mobility status; and
one or more measurement results of a link (e.g., a sidelink, etc.) between the first UE and the second UE.

In accordance with an exemplary embodiment, the first UE may forward the status information of the second UE to the base station. According to an exemplary embodiment, the first UE may schedule one or more transmissions to the second UE according to the status information of the second UE.

In accordance with an exemplary embodiment, the one or more messages may explicitly or implicitly indicate that the one or more messages are for the first UE and/or for the second UE. In an embodiment, the one or more messages may not be forwarded to the second UE by the first UE in the case that the one or more messages are only for the first UE.

In accordance with an exemplary embodiment, the one or more messages may further include an indicator indicating whether the one or more messages are for the first UE and/or for the second UE. The indicator may be an explicit mapping/indication, or an implicit indication. It can be appreciated that the one or more messages may each include an indicator to indicate whether the corresponding message is intended for the first UE, for the second UE or for both.

In accordance with an exemplary embodiment, the first UE may be configured with capability information (e.g., one or more capability bits, etc.) indicating whether the first UE supports the first paging message and/or the second paging message in relay communication.

In accordance with an exemplary embodiment, the second UE may be configured with capability information (e.g., one or more capability bits, etc.) indicating whether the second UE supports the first paging message and/or the second paging message in relay communication.

FIG. 4B is a flowchart illustrating a method 420 according to some embodiments of the present disclosure. The method 420 illustrated in FIG. 4B may be performed by a second UE (e.g., a remote UE, etc.) or an apparatus communicatively coupled to the second UE. In accordance with an exemplary embodiment, the second UE may be configured to support D2D communication (e.g., V2X or SL communication, etc.) with other devices. In an exemplary embodiment, the second UE may be configured to communicate with a network node (e.g., a gNB, etc.) directly or via a relay (e.g., the UE-to-UE relay, the UE-to-NW relay, etc.).

According to the exemplary method 420 illustrated in FIG. 4B, the second UE may receive one or more messages from a base station via a first UE (e.g., the first UE as described with respect to FIG. 4A), as shown in block 422. The one or more messages may include a first paging message in physical layer signaling. In accordance with an exemplary embodiment, the one or more messages may further include a second paging message in signaling (e.g., RRC signaling, etc.) on a protocol layer above the physical layer.

In accordance with an exemplary embodiment, the one or more messages received by the second UE according to the method 420 may correspond to the one or more messages forwarded to the second UE by the first UE according to the method 410. Thus, the one or more messages as described with respect to FIG. 4A and FIG. 4B may have the same or similar contents and/or feature elements.

In accordance with an exemplary embodiment, the second UE may receive the one or more messages in a groupcast, broadcast or dedicated transmission from the first UE. In accordance with another exemplary embodiment, the second UE may receive the one or more messages from the first UE according to a configuration by the base station, or a predetermined configuration. As described with respect to FIG. 4A, the second UE may receive the one or more messages from the first UE in SCI signaling, RRC signaling, a MAC CE and/or a control data unit.

In accordance with an exemplary embodiment, the SCI signaling according to the method 420 may correspond to the SCI signaling according to the method 410. Thus, the SCI signaling as described with respect to FIG. 4A and FIG. 4B may have the same or similar contents and/or feature elements.

In accordance with an exemplary embodiment, the second UE may optionally transmit status information to the first UE, as shown in block 424. The status information may indicate activity status of the second UE.

In accordance with an exemplary embodiment, the status information according to the method 420 may correspond to the status information according to the method 410. Thus, the status information as described with respect to FIG. 4A and FIG. 4B may have the same or similar contents and/or feature elements.

FIG. 4C is a flowchart illustrating a method 430 according to some embodiments of the present disclosure. The method 430 illustrated in FIG. 4C may be performed by a base station (e.g., a gNB, an AP etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay.

According to the exemplary method 430 illustrated in FIG. 4C, the base station may transmit one or more messages to a second UE (e.g., the second UE as described with respect to FIG. 4B) via a first UE (e.g., the first UE as described with respect to FIG. 4A), as shown in block 432. The one or more messages may include a first paging message in physical layer signaling. In accordance with an exemplary embodiment, the one or more messages may further include a second paging message in signaling on a protocol layer above the physical layer. Optionally, the base station may inform the first UE of a configuration about forwarding the one or more messages from the first UE to the second UE.

In accordance with an exemplary embodiment, the one or more messages transmitted by the base station according to the method 430 may correspond to the one or more messages received by the first UE according to the method 410. Thus, the one or more messages as described with respect to FIG. 4A and FIG. 4C may have the same or similar contents and/or feature elements.

In accordance with an exemplary embodiment, the base station may optionally receive status information of the second UE from the first UE, as shown in block 434. The status information indicates activity status of the second UE. In accordance with an exemplary embodiment, the base station may schedule one or more transmissions to the second UE according to the status information of the second UE.

In accordance with an exemplary embodiment, the status information according to the method 430 may correspond to the status information according to the method 410. Thus, the status information as described with respect to FIG. 4A and FIG. 4C may have the same or similar contents and/or feature elements.

The various blocks shown in FIGS. 4A-4C may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

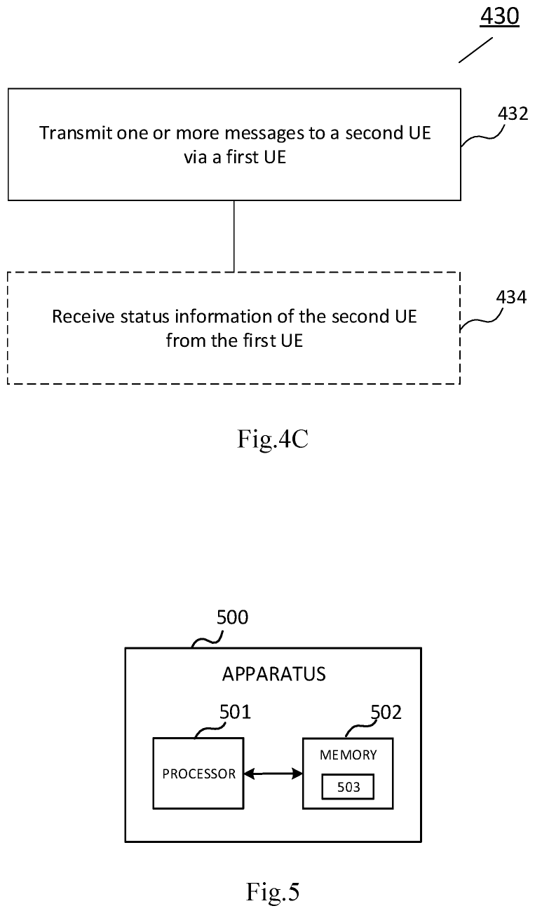

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a first UE as described with respect to FIG. 4A, a second UE as described with respect to FIG. 4B, or a base station as described with respect to FIG. 4C. In such cases, the apparatus 500 may be implemented as a first UE as described with respect to FIG. 4A, a second UE as described with respect to FIG. 4B, or a base station as described with respect to FIG. 4C.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. In other implementations, the one or more memories 502 and the computer program codes 503 may be configured to, with the one or more processors 501, cause the apparatus 500 at least to perform any operation of the method as described in connection with FIG. 4C. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

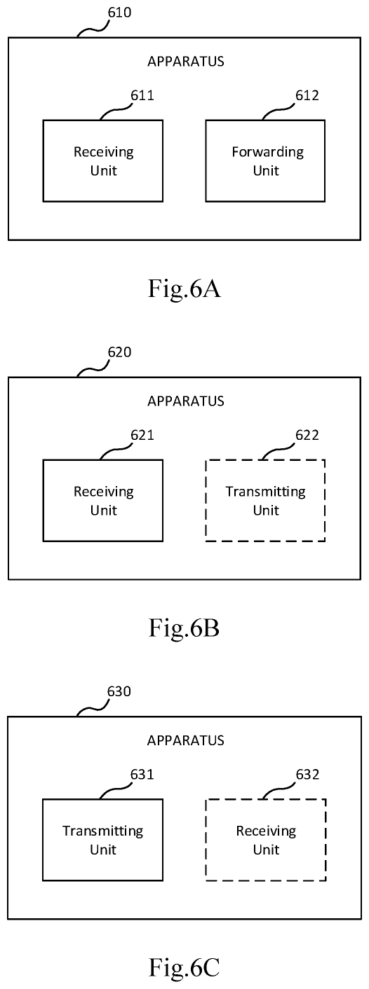

FIG. 6A is a block diagram illustrating an apparatus 610 according to some embodiments of the present disclosure. As shown in FIG. 6A, the apparatus 610 may comprise a receiving unit 611 and a forwarding unit 612. In an exemplary embodiment, the apparatus 610 may be implemented in a first UE such as a relay capable UE. The receiving unit 611 may be operable to carry out the operation in block 412, and the forwarding unit 612 may be operable to carry out the operation in block 414. Optionally, the receiving unit 611 and/or the forwarding unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and optionally a transmitting unit 622. In an exemplary embodiment, the apparatus 620 may be implemented in a second UE such as a remote UE. The receiving unit 621 may be operable to carry out the operation in block 422, and the transmitting unit 622 may be operable to carry out the operation in block 424. Optionally, the receiving unit 621 and/or the transmitting unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a transmitting unit 631 and optionally a receiving unit 632. In an exemplary embodiment, the apparatus 630 may be implemented in a base station (e.g., a gNB, etc.). The transmitting unit 631 may be operable to carry out the operation in block 432, and the receiving unit 632 may be operable to carry out the operation in block 434. Optionally, the transmitting unit 631 and/or the receiving unit 632 may be operable to carry out more or less operations to implement the proposed methods according to the exemplary embodiments of the present disclosure.

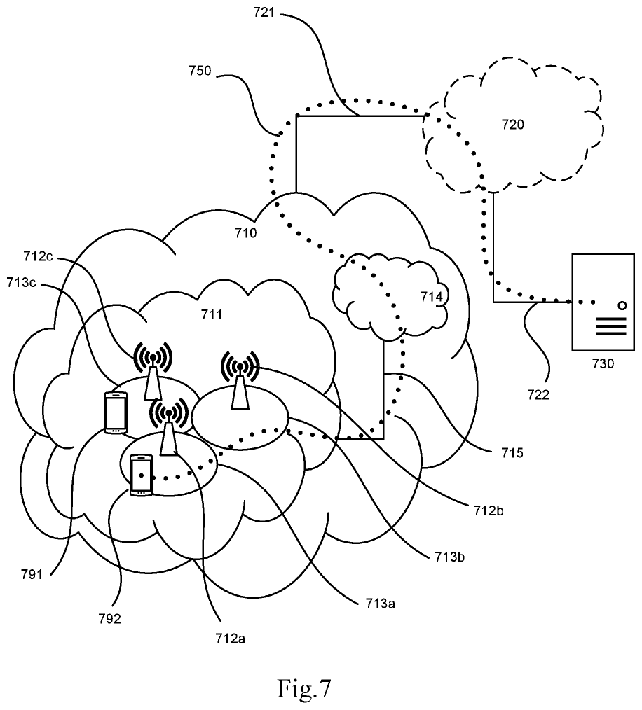

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

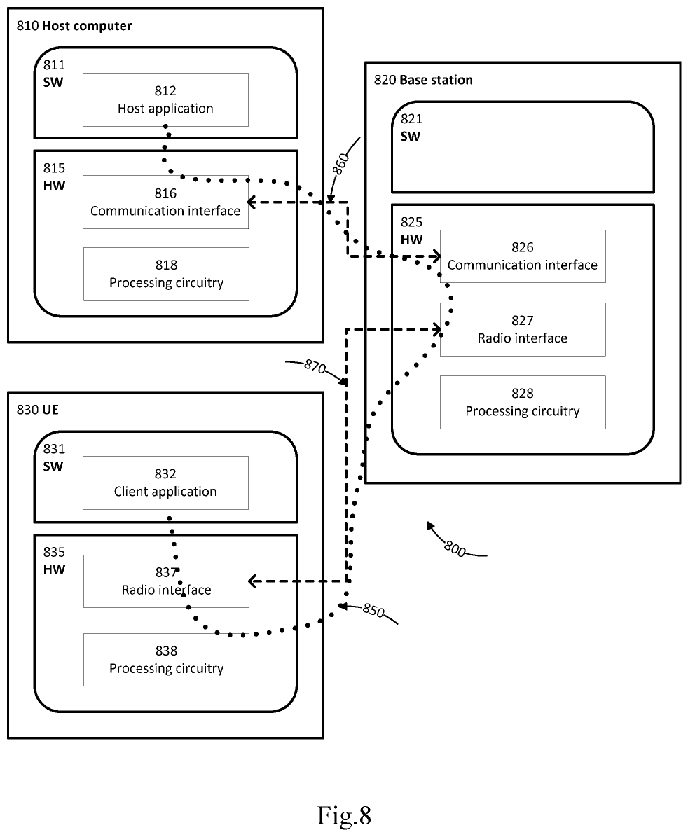

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

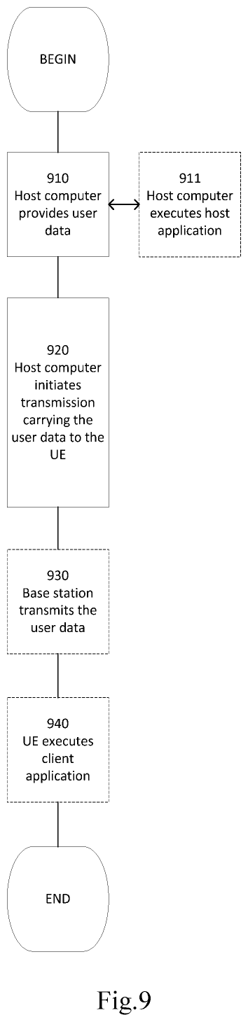

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

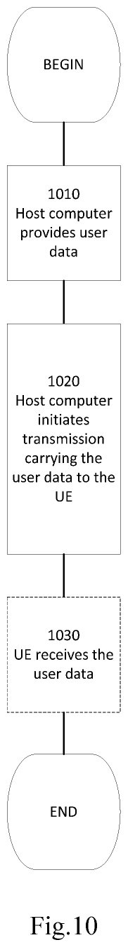

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

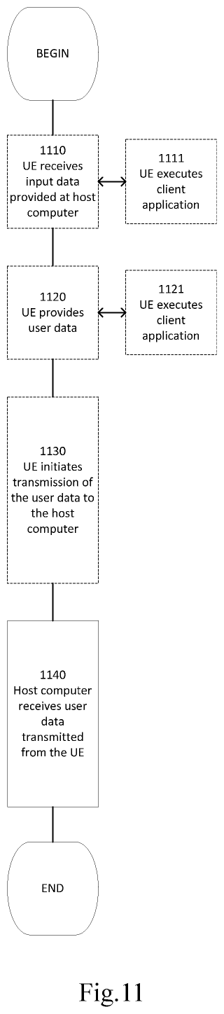

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

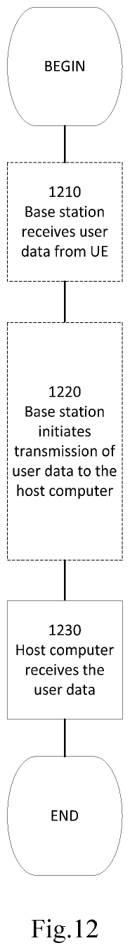

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 430 as describe with respect to FIG. 4C.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 430 as describe with respect to FIG. 4C.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 410 as describe with respect to FIG. 4A, or any step of the exemplary method 420 as describe with respect to FIG. 4B.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 410 as describe with respect to FIG. 4A, or any step of the exemplary method 420 as describe with respect to FIG. 4B.

According to some exemplary embodiments, there is provided a method implemented in a communication system which may include a host computer, a base station and a UE. The method may comprise, at the host computer, receiving user data transmitted to the base station from the UE which may perform any step of the exemplary method 410 as describe with respect to FIG. 4A, or any step of the exemplary method 420 as describe with respect to FIG. 4B.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 410 as describe with respect to FIG. 4A, or any step of the exemplary method 420 as describe with respect to FIG. 4B.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 430 as describe with respect to FIG. 4C.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 430 as describe with respect to FIG. 4C.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-45. (canceled)

46. A method performed by a first user equipment, comprising:
receiving one or more messages for a second user equipment from a base station, wherein the one or more messages includes a first paging message in physical layer signaling; and
forwarding the one or more messages to the second user equipment.

47. The method of claim 46, wherein the first user equipment forwards the one or more messages to the second user equipment in a groupcast or broadcast transmission or wherein the first user equipment forwards the one or more messages to the second user equipment in a dedicated transmission.

48. The method of claim 46, wherein the first user equipment forwards the one or more messages to the second user equipment in one or more of:
sidelink control information signaling;
radio resource control signaling;
a control element for medium access control;
a control data unit; or
a second paging message in signaling on a protocol layer above the physical layer.

49. The method of claim 48, wherein
the sidelink control information signaling includes one or more of:
an indicator of the first paging message;
the first paging message;
a frequency domain resource assignment; and
a time domain resource assignment; or
the sidelink control information signaling includes one or more of:
an indicator of the first paging message;
the first paging message;
a frequency domain resource assignment;
a time domain resource assignment;
an indicator of the second paging message; and
paging information of the second user equipment.

50. The method of claim 46, wherein the first user equipment forwards the one or more messages to the second user equipment according to a configuration provided by the base station or according to a predetermined configuration.

51. The method of claim 46, further comprising:
receiving status information from the second user equipment, wherein the status information indicates activity status of the second user equipment; wherein the status information includes one or more of:
one or more time occasions during which the second user equipment is active;
duration of the second user equipment being in active state;
radio link status;
buffer status;
power headroom;
mobility status; and
one or more measurement results of a link between the first user equipment and the second user equipment.

52. The method of claim 51, further comprising:
forwarding the status information of the second user equipment to the base station.

53. The method of claim 51, further comprising:
scheduling one or more transmissions to the second user equipment according to the status information of the second user equipment.

54. The method of claim 46, wherein the one or more messages further include an indicator indicating whether the one or more messages are for the first user equipment and/or for the second user equipment.

55. The method of claim 46, wherein the second user equipment is configured with capability information indicating whether the second user equipment supports the first paging message and/or the second paging message in relay communication.

56. A first user equipment, comprising:
one or more processors; and
one or more memories comprising computer program codes, the one or more memories and the computer program codes being configured to, with the one or more processors, cause the first user equipment at least to:
receive one or more messages for a second user equipment from a base station, wherein the one or more messages includes a first paging message in physical layer signaling; and
forward the one or more messages to the second user equipment.

57. A method performed by a second user equipment, comprising:
receiving one or more messages from a base station via a first user equipment, wherein the one or more messages includes a first paging message in physical layer signaling.

58. The method of claim 57, wherein the second user equipment receives the one or more messages in a groupcast or broadcast transmission from the first user equipment, or wherein the second user equipment receives the one or more messages in a dedicated transmission from the first user equipment.

59. The method of claim 57, wherein the second user equipment receives the one or more messages from the first user equipment in one or more of:
sidelink control information signaling;
radio resource control signaling;
a control element for medium access control; and
a control data unit.

60. The method of claim 59, wherein the sidelink control information signaling includes one or more of:
an indicator of the first paging message;
the first paging message;
a frequency domain resource assignment;
a time domain resource assignment;
a second paging message in signaling on a protocol layer above the physical layer.

61. The method of claim 59, wherein the sidelink control information signaling includes one or more of:
an indicator of the first paging message;
the first paging message;
a frequency domain resource assignment;
a time domain resource assignment;
an indicator of the second paging message; and
paging information of the second user equipment.

62. The method of claim 57, wherein the second user equipment receives the one or more messages from the first user equipment according to a configuration provided by the base station or according to a predetermined configuration.

63. The method of claim 57, further comprising:
transmitting status information to the first user equipment, wherein the status information indicates activity status of the second user equipment and wherein the status information includes one or more of:
one or more time occasions during which the second user equipment is active;
duration of the second user equipment being in active state;
radio link status;
buffer status;
power headroom;
mobility status; or
one or more measurement results of a link between the first user equipment and the second user equipment.

64. The method of claim 57, wherein the one or more messages further include an indicator indicating whether the one or more messages are for the first user equipment and/or for the second user equipment.

65. The method of claim 57, wherein the second user equipment is configured with capability information indicating whether the second user equipment supports the first paging message and/or the second paging message in relay communication.
